(19) United States
(12) Patent Application Publication
(10) Pub. No.: US 2026/0168463 A1
(43) Pub. Date: Jun. 18, 2026

(54) CYLINDER LINER FOR INTERNAL COMBUSTION ENGINE

(71) Applicant: Caterpillar Inc., Peoria, IL (US)

(72) Inventors: Aaron Ness, Battle Ground, IN (US); Christopher L. Batta, West Lafayette, IN (US); Adam J. Clute, Lafayette, IN (US)

(73) Assignee: Caterpillar Inc., Peoria, IL (US)

(21) Appl. No.: 18/979,170

(22) Filed: Dec. 12, 2024

(51) Int. Cl. F02F 11/00; F02F 1/00

(52) U.S. Cl. CPC F02F 11/005; F02F 1/004; F02F 11/002

(57) ABSTRACT

The present application includes a cylinder liner for an internal combustion engine. This cylinder liner includes a main body portion forming a cylinder bore, with a spot face configured to interface with a first portion of a cylinder head gasket. A flange extends outward from the main body portion, with an outer face configured to interface with a second portion of the cylinder head gasket. The spot face is recessed below the outer face, making the outer face proud of the spot face. The cylinder head gasket is interposed between substantially the entirety of the spot face and the outer face and the cylinder head, forming a seal.

### TECHNICAL FIELD

The present disclosure relates to an internal combustion engine. More particularly, the present disclosure relates to a cylinder head gasket and cylinder liner of the internal combustion engine.

### BACKGROUND

Machinery, for example, agricultural, industrial, construction or other heavy machinery can be propelled by an internal combustion engine(s). Internal combustion engines can be used for other purposes such as for power generation. Internal combustion engines combust a mixture of air and fuel(s) in cylinders and thereby produce drive torque and power. Internal combustion engines may be designed to run on gasoline fuel, in which a spark plug initiates combustion, on diesel fuel, that is compression ignited, or on other fuels, such as gaseous fuels. Gaseous fuels are fuels that are in a gaseous state under ordinary conditions such as at standard temperature and pressure.

Internal combustion engines utilize gaskets to form seals between various components including the cylinder head and various components of the engine including the engine block. United States Patent Nos. 6,931,705B2 and 5,377,643A and United States Patent Application No. 2016/0032862A1 disclose use of gaskets for sealing between the cylinder head and other parts of an internal combustion engine. However, these patent applications and patent do not recognize a cylinder head gasket and cylinder liner with the construction and other benefits in the manner disclosed herein.

### SUMMARY

In an example according to this disclosure, a cylinder liner for an internal combustion engine is disclosed. The cylinder liner includes a main body portion forming a cylinder bore of the internal combustion engine, wherein the main body portion has a spot face that is configured to interface with a first portion of a cylinder head gasket. The cylinder liner further includes a flange extending outward from the main body portion, wherein the flange includes an outer face that is configured to interface with a second portion of the cylinder head gasket. The spot face is recessed a distance below the outer face such that the outer face is proud of the spot face..

In another example according to this disclosure, an internal combustion engine is disclosed. The internal combustion engine can include a cylinder head, an engine block, and a cylinder liner received at least partially within the engine block. The cylinder liner includes a main body portion that forms a cylinder bore configured to receive a piston therein and a flange extending outward from the main body portion, wherein the main body portion has a spot face and the flange has an outer face. The spot face is recessed a distance below the outer face such that the outer face is proud of the spot face. The internal combustion engine further includes a cylinder head gasket arranged between substantially an entirety of the spot face and the cylinder head and arranged between substantially an entirety of the outer face and the cylinder head, wherein the cylinder head gasket forms a seal with the spot face and the outer face.

In yet another example according to this disclosure, a method of sealing a cylinder bore of an internal combustion engine is disclosed. The method includes providing a cylinder head and a cylinder liner that defines the cylinder bore, wherein the cylinder liner includes a spot face extending from the cylinder liner and the cylinder liner includes an outer face radially outward of the spot face. The spot face is recessed a distance below the outer face such that the outer face is proud of the spot face with respect to the cylinder head. The method further includes interposing a cylinder head gasket between the cylinder liner and the cylinder head to cover substantially all of the spot face and substantially all of the outer face, and compressing the cylinder head gasket against the spot face and the outer face.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an exemplary internal combustion engine in accordance with an example of the present application.

FIG. 2A is an enlarged perspective view of a plurality of cylinder heads mounted to an engine block of the internal combustion engine in accordance with an example of the present application.

FIG. 2B is a perspective view of the internal combustion engine of FIG. 2A with the plurality of cylinder heads removed to show a plurality of cylinder head gaskets, cylinder liners, and spacer plates in accordance with an example of the present application.

FIG. 3 is a cross-sectional view a portion of the internal combustion engine including the cylinder head, the cylinder head gasket, the spacer plate and part of the cylinder liner in accordance with an example of the present application.

FIG. 3A is an enlarged schematic view from cross-sectional view of FIG. 3 in accordance with an example of the present application.

FIG. 4 is a perspective view of the cylinder head gasket in accordance with an example of the present application.

FIG. 5 is an enlarged schematic view of the cross-section of FIG. 3A showing an application of forces and other details of features of components according to an example of the present application.

### DETAILED DESCRIPTION

Examples of the present disclosure are now described with reference to the accompanying drawings. The following description is merely exemplary in nature and is not intended to limit the present disclosure, application, or use. Examples described set forth specific components, devices, and methods, to provide an understanding of embodiments of the present disclosure. It will be apparent to those skilled in the art that specific details need not be employed and that examples may be embodied in many different forms. Thus, the examples provided should not be construed to limit the scope of the claims.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Further, relative terms, such as, for example, “about,” “substantially,” “generally,” and “approximately” are used to indicate a possible variation of ±10% in a stated value. As used herein, a “gaseous fuel” may include gaseous fuel such as, natural gas, methane, butane, propane, bio-gas, landfill gas, hydrogen, and blends thereof, for example. Natural gas is an exemplary gaseous fuel having various levels of purity. As used herein “natural gas” refers to both pure and relatively impure forms having various amounts of methane and other constituents. The gaseous fuel may be provided to an intake component of the internal combustion engine in a compressed form. The gaseous fuel may be stored in a liquid form in a storage tank, and converted to gas (e.g. by heating) prior to introduction to the intake component. As used herein, a “liquid fuel” does not include gaseous fuel and may include gasoline, diesel, methanol, ethanol, or any other liquid fuel.

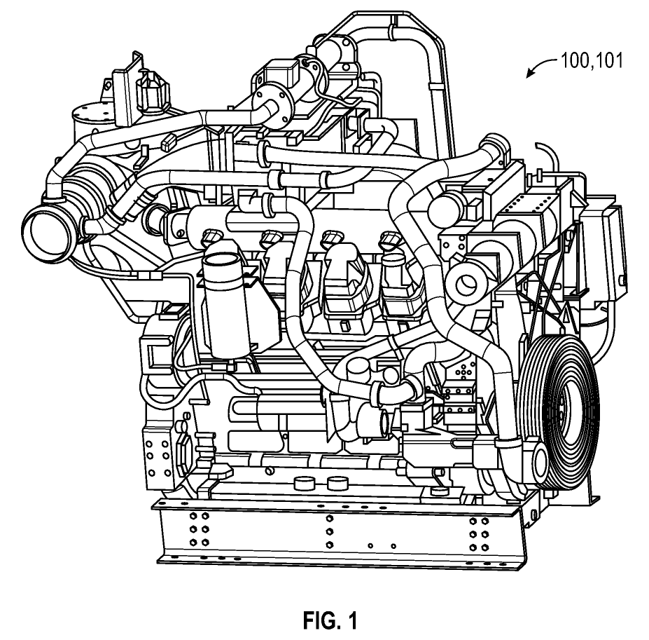

FIG. 1 depicts parts of an internal combustion engine 100 (sometimes referred to as simply as “engine” herein) in accordance with this disclosure. The engine 100 can be used for power generation such as for the propulsion of vehicles or other machinery or for stationary power generation. While the internal combustion engine 100 is depicted as a gas engine 101, embodiments are not limited to gas engines, and embodiments can be implemented on, for example, diesel engines. The gas engine 101 may be any engine configured to generate power using a gaseous fuel, for example, such as an internal combustion engine. Gaseous fuels are fuels that are in a gaseous state under ordinary conditions such as at standard temperature and pressure. The internal combustion engine 100 can include various power generation platforms, and can use various a single fuel of dual fuels including, for example, liquid fuel and/or gaseous fuel. Stationary engines may be used to drive immobile equipment, such as pumps, generators, mills, or factory equipment. It is understood that the present disclosure can apply to any number of piston-cylinder arrangements and a variety of engine configurations including, but not limited to, V-engines, inline engines, and horizontally opposed engines, as well as overhead cam and cam-in-block configurations. Vehicles and working machinery that can be driven include those related to various industries, including, as examples, construction, agriculture, forestry, transportation, material handling, waste management, etc.

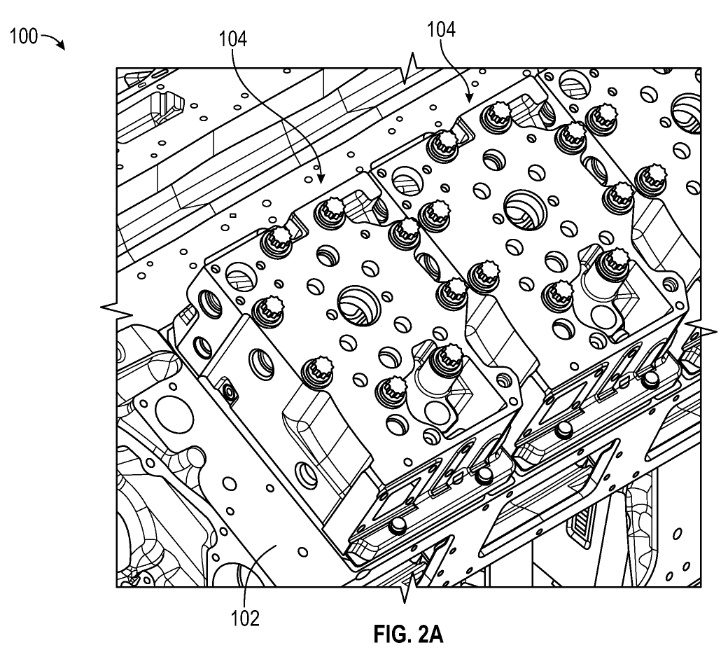

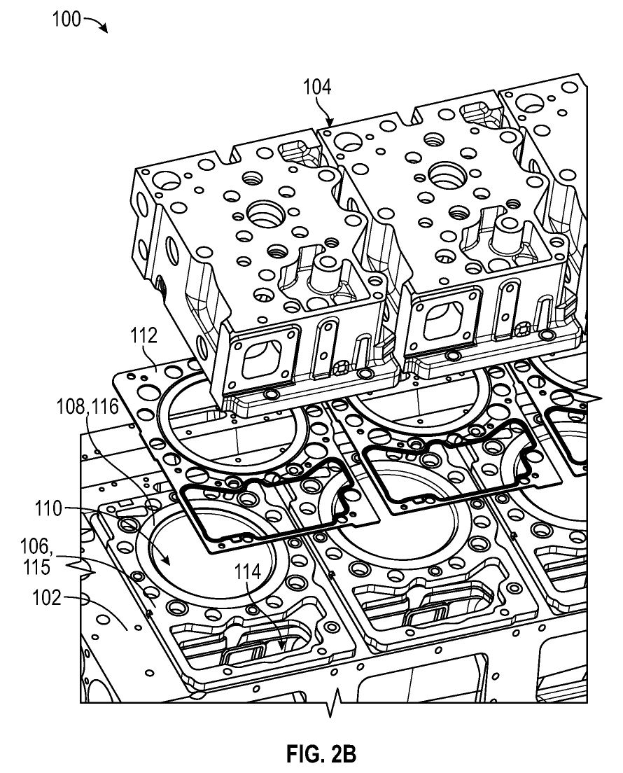

FIG. 2A shows portions of engine 100 that include an engine block 102 and a cylinder head 104. The cylinder head 104 can be mounted to the engine block 102 such as via a spacer plate 106 as shown in the exploded view of FIG. 2B. The engine block 102 receives the cylinder liners (shown in FIG. 2B and discussed subsequently). The cylinder liners may be arranged in any configuration such as inline, radial, “V”, or the like as discussed above. The cylinder liners can define bores that form parts of combustion chambers in which pistons reciprocate. Energy generated from combustion of the fuel inside the cylinder bores can be converted to rotational energy of the crankshaft by the pistons.

The cylinder head 104 and/or a rocker box (not shown) can form a housing for components such as a fuel injector (not shown). Each fuel injector can be in fluid communication with a respective combustion chamber and can be mounted in the cylinder head 104 and/or rocker box. The cylinder head 104 may house one or more components and/or systems (not shown) of the engine 100 such as a valve train, an intake manifold, an exhaust manifold, sensors, etc. Additionally, the engine 100 may include various other components and/or systems (not shown) such as a crankcase, a fuel system, an air system, a cooling system, a turbocharger, an exhaust gas recirculation system, an exhaust gas aftertreatment system, etc.

The engine 100 may also include a fuel rail system. This system can be double walled for enclosure in some cases. The fuel rail system can be fluidly connected to one or more fuel pumps (not shown). The fuel rail system can be configured to receive pressurized gaseous or liquid fuel therein from the one or more fuel pumps. The fuel rail system can be fluidly connected to fuel injectors (not shown) associated with the cylinders of the engine 100. Accordingly, the fuel rail system is configured to supply the pressurized gaseous fuel and/or liquid fuel to each of the fuel injectors.

FIG. 2B shows an exploded view with the cylinder head 104 removed from the spacer plate 106 and the engine block 102. FIG. 2B additionally shows a cylinder liner 108 that forms a cylinder bore 110, a cylinder head gasket 112 and a water ferrule 114 formed by the engine block 102 of the internal combustion engine 100.

As shown in FIG. 2B, the cylinder head gasket 112 is configured to be interposed between the cylinder liner 108 and parts, all or substantially all of the spacer plate 106 and the cylinder head 104. The cylinder head gasket 112 can extend to adjacent (within less than 10 mm, less than 5 mm, less than 2.5 mm, less than 1 mm or the like) of the cylinder bore 110. The cylinder head gasket 112 can additionally extend between parts, all or substantially all of the cylinder liner 108 and the cylinder head 104. According to the example shown in FIG. 2B, the cylinder head gasket 112 can be configured to extend over substantially an entirety of the spacer plate 106. As shown in FIG. 2B, the cylinder head gasket 112 can be shaped along an outer edge to generally correspond to a shape of an outer edge the spacer plate 106. Additionally, the cylinder head gasket 112 can be configured to accommodate the water ferrule 114 by extending around the water ferrule 114 along the spacer plate 106. The water ferrule 114 can be a recess configured to communicate water up into the cylinder head 104.

As shown in FIG. 2B, the engine 100 includes multiple cylinder heads 104, multiple cylinder liners 108 and multiple cylinder head gaskets 112. This arrangement facilitates individual service of the cylinder head 104, cylinder liner 108 and cylinder head gasket 112 should it be desired.

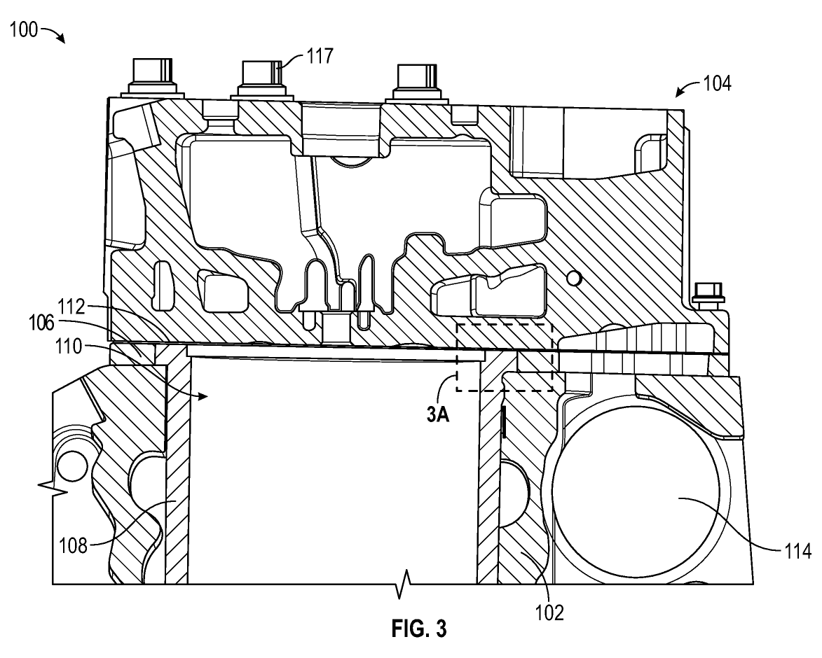

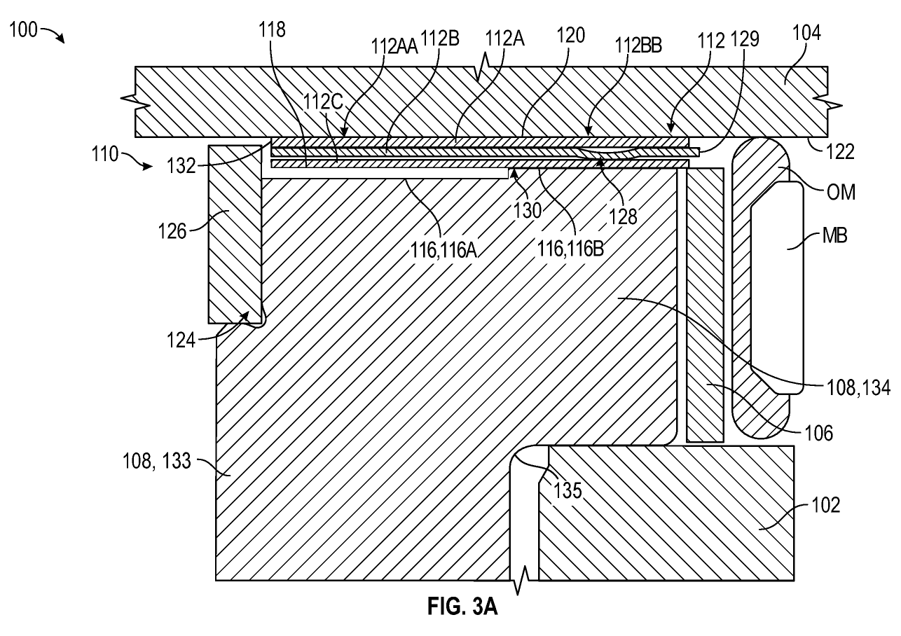

Spacer plate 106 can be proud of the engine block 102. The spacer plate 106 can be a dedicated component separate from and attached to the engine block 102. Alternatively, the spacer plate 106 can be part of the engine block 102 specifically configured for mounting, for example. The spacer plate 106 can be configured to couple with the cylinder head 104 via threaded bores or other features that receive fasteners (fasteners shown in FIGS. 2A and 3) as known in the art. Thus, the spacer plate 106 has a shape the facilitates mounting of the cylinder head 104 thereto. The spacer plate 106 can surround or partially surround the cylinder liner 108. The spacer plate 106 (and/or the engine block 102) can be configured to receive the cylinder liner 108 therein or thereon. As shown in FIG. 2B, an outer surface 115 of the spacer plate 106 can be substantially flush with an outer surface 116 of the cylinder liner 108. The cylinder bore 110 of the cylinder liner 108 is an aperture in which a piston (not shown) can reciprocate. The spacer plate 106 can include a plenum or other opening configured to accommodate part of the water ferrule 114, which extends between the engine block 102 and the cylinder head 104.

FIG. 3 is a cross-sectional view of one of the cylinder heads 104 and portions of the engine block 102, spacer plate 106, cylinder liner 108 and water ferrule 114. FIG. 3 additionally shows the cylinder bore 110 and cylinder head gasket 112. As shown in FIG. 3, the cylinder head gasket 112 is interposed substantially entirely between the cylinder liner 108 and the cylinder head 104 and between parts of the spacer plate 106 and the cylinder head 104. FIG. 3 shows fasteners 117 that couple the cylinder head 104 to the engine block 102 and compress the cylinder head gasket 112.

FIG. 3A is an enlarged schematic view of the cross-section of FIG. 3. FIG. 3 illustrates parts of the cylinder head 104, the spacer plate 106, cylinder liner 108, the cylinder bore 110, the cylinder head gasket 112 as previous discussed an illustrated. As FIG. 3A is schematically drawn, gaps shown in FIG. 3A are highly exaggerated and the shape of some components and gaps and distances are not drawn to scale.

The cylinder head gasket 112 is sandwiched between abutted and pinched (compressed) by the cylinder head 104 and the cylinder liner 108 via the force of fasteners or other components the couple the cylinder head 104 to the internal combustion engine 100. The cylinder head gasket 112 can be relatively more crushable/conformable/deformable as compared with the spacer plate 106 or engine block 102. This conformability of the cylinder head gasket 112 allows the cylinder head gasket 112 to conform with outer surfaces of both the cylinder liner 108 and the cylinder head 104 in a manner that creates as seal against methane or other gaseous fuel passing away from cylinder bore 110.

FIG. 3A additionally shows the construction and positioning of the cylinder head gasket 112 and the cylinder liner 108. As shown in FIG. 3A, the outer surface 116 is a top surface of the cylinder liner 108. The outer surface 116 can include a spot face 116A and an outer face 116B. The spot face 116A can be radially inward of the outer face 116B. The spot face 116A can be associated with, be a feature or part of or otherwise correspond to a main body portion 133 of the cylinder liner 108. The outer face 116B can be associated with, be a feature or part of or otherwise correspond to a flange 134 of the cylinder liner 108. As shown in the example of FIG. 3A, no portion of the main body portion 133 along the spot face 116A has a greater outer extent (extends further outward) than any portion of the flange 134 along the outer face 116B. Additionally, as shown in FIG. 3A, no features (e.g., projections, grooves, depressions, bumps, etc.) are positioned between the spot face 116A and the outer face 116B. Rather, the spot face 116A transitions immediately and without interruption into the outer face 116B. Put another way, the spot face 116A is positioned next to and transitions to the outer face 116B. The outer face 116B can form the top or outermost surface of the cylinder liner 108.

The cylinder liner 108 can include the main body portion 133 and the flange 134. The main body portion 133 can be a generally cylindrically shaped portion of the cylinder liner 108 and can define the cylinder bore 110 along with other features discussed below. The flange 134 can extend radially outward from and can be connected to the main body portion 133. The flange 134 can be configured to seat against the engine block 102 or intermediate components coupled to the engine block 102. The outer radial extent of the flange 134 exceeds an outer radial extent of the main body portion 133 such that the flange 134 has a greater diameter than the main body portion 133.

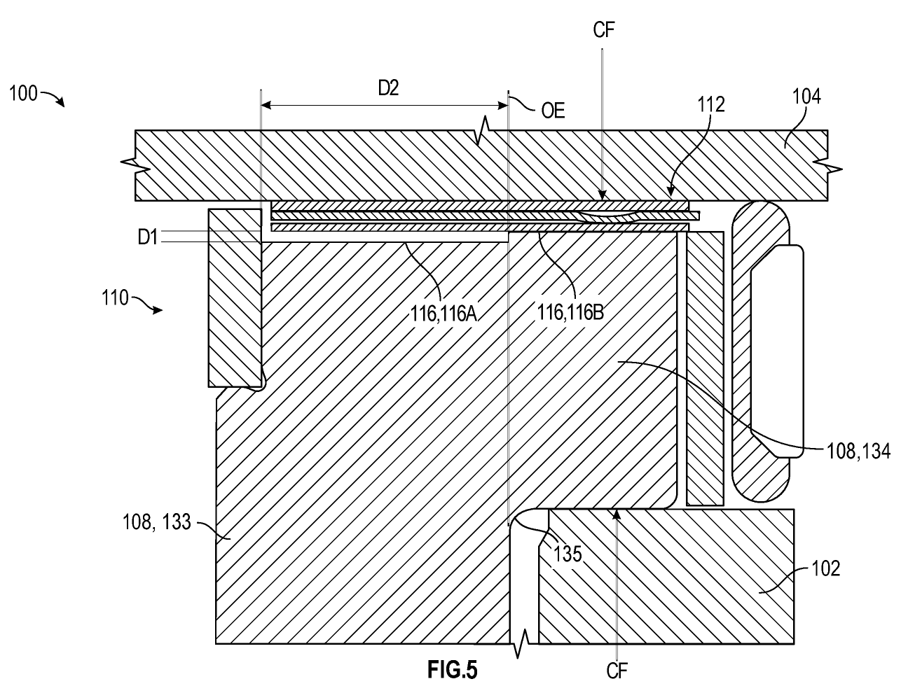

As shown in FIG. 3A, the spot face 116A is recessed a distance (indicated with D1 in FIG. 5) below the outer face 116B such that the outer face 116B is proud of the spot face 116A. The spot face 116A is intentionally created to be recessed relative to the outer face 116B. Thus, the cylinder liner 108 includes an intentionally created feature (e.g., a recess or groove) at and along the outer surface 116 that faces the cylinder head gasket 112. This feature is radially inward of a prouder surface that can be associated with the flange 134. The spot face 116A can have a substantially flat extent, similarly the outer face 116B can have a substantially flat extent. The transition between the fist spot face 116A and the outer face 116B can be an abrupt (vertical substantially vertical change due to a transverse surfaces meeting) or can be filleted, chamfered or otherwise shaped.

The cylinder head gasket 112 can be conforming in shape along one or both of a bottom surface 118 and a top surface 120 thereof. As shown, the cylinder head 104 can be substantially flat along a bottom surface 122 thereof. The bottom surface 122 can abut the top surface 120. The bottom surface 118 can abut the outer surface 116 including all or some of the spot face 116A (substantially filling the distance D1 of FIG. 5) and the outer face 116B. Thus, both the spot face 116A and the outer face 116B are sealing surfaces according to some examples. Thus, the cylinder head gasket 112 forms a seal with the spot face 116A and the outer face 116B.

FIG. 3A shows the cylinder head gasket 112 can extend to or adjacent (only slightly spaced within less than 10 mm, less than 5 mm, less than 2.5 mm, less than 1 mm) the cylinder bore 110 as previously discussed. Similarly, the spot face 116A can extend to or adjacent (being only slightly spaced within less than 10 mm, less than 5 mm, less than 2.5 mm, less than 1 mm) the cylinder bore 110. As shown in FIG. 3A, the spot face 116A can extend to a groove 124 configured to receive a cuff ring 126 therein. The groove 124 can be a feature of the cylinder bore 110. Thus, the spot face 116A can extend to or adjacent the cuff ring 126 according to some examples. According to some examples, an inner radial edge of the cylinder head gasket 112 can be flush or substantially flush (only slightly spaced within less than 10 mm, less than 5 mm, less than 2.5 mm, less than 1 mm) with the cylinder bore 110.

FIG. 3A shows an example where the cylinder bore 110 includes the groove 124 and the cuff ring 126 therein. The cuff ring 126 interfaces with the piston (not shown) during a top of the stroke of the piston. The cuff ring 126 is configured to clean the piston as known in the art. Thus, according to some examples the cylinder head gasket 112 and/or the spot face 116A can extend to or adjacent (within less than 10 mm, less than 5 mm, less than 2.5 mm, less than 1 mm) the cuff ring 126.

The cylinder head gasket 112 can be a multi-layer steel (MLS) gasket (e.g., stainless or spring steel) although embodiments are not limited to steel and can include any metal or other type of steel, nickel, etc. The cylinder head gasket 112 portion can include an upper metal layer 112A, a middle metal layer 112B and a lower metal layer 112C. The upper metal layer 112A can form the top surface 120. The lower metal layer 112C can form the bottom surface 118. While three layers are depicted, this is for purposes of clarity only. The MLS gasket can include several thinner layers or layers of variable thickness. The plurality of metal layers 112A, 122B, and 112C (and indeed the cylinder head gasket 112) can be configured to substantially eliminate any direct abutment between the cylinder liner 108 and the cylinder head 104. Thus, the cylinder head gasket 112 is configured to substantially eliminate any direct abutment between the cylinder liner 108 and the cylinder head 104 when the cylinder head compresses the cylinder head gasket 112 (this loaded configuration for the cylinder head gasket 112 in FIG. 3A and 5). This compression and deformation of the cylinder head gasket 112 is due to the construction of the cylinder head gasket 112 and the plurality of metal layers 112A, 112B and 112C (and indeed the cylinder head gasket 112) being configured to be interposed between substantially an entirety of an interface/joint between the cylinder head 104 and the cylinder liner 108. Thus, the cylinder head gasket 112 is interposed between substantially an entirety of the spot face 116A and the outer face 116A and the cylinder head 104 according to some examples. However, in some examples, the cylinder head gasket 112 can be recessed slightly such that a small portion of the spot face 116A (e.g., less than 10 mm, less than 5 mm, less than 2 mm, less than 1 mm, less than 0.1 mm, less than 0.01 mm, less than 0.001 mm) is exposed to directly face the cylinder head 104.

As shown in FIG. 3A, the spot face 116A is configured to interface with a first portion 112AA of the cylinder head gasket 112. The outer face 116B is configured to interface with a second portion 112BB of the cylinder head gasket 112. The first portion 112AA and the second portion 112BB can however form the same inner surface 120, which can be substantially flat. The upper metal layer 112A can be spot welded, embossed, molded or otherwise affixed to the middle layer 112B at various locations. Similarly, the lower metal layer 112C can be spot welded, embossed, molded or otherwise affixed to the middle metal layer 112B at various locations. As shown in FIG. 3A, the middle layer 112B can be shaped with a convex projection or bump 128 adjacent an outer end 129 thereof. The bump 128 can project toward the lower metal layer 112C. However, the orientation of the bump 128 can be reversed in other embodiments. This bump 128 can form a continuous ridge extending circumferentially around and above the cylinder liner 108 between the lower metal layer 112C and the top metal layer 112A. The bump 128 forms an additional sealing feature within the cylinder head gasket 112. The upper metal layer 112A, the middle metal layer 112B and the lower metal layer 112C can be compressed into sealing engagement (e.g., by a compaction force, by a bolt force, etc.) by a compression force applied on the cylinder head gasket 112.

The bump 128 can be positioned at or spaced from an outer radial edge of the cylinder liner 108. However, the bump 128 can be positioned in another location such as more closely adjacent the cylinder bore 110 or above the spacer plate 106 according to other examples. As a result of the bump 128, the cylinder head gasket 112 has a flange portion 130 that extends radially inward from the bump 128 to an inner end 132 adjacent or at the cylinder bore 110. At the flange portion 130, the upper metal layer 112A, the middle layer 112B and the lower metal layer 112C can extend substantially parallel with one another. The upper metal layer 112A, the middle layer 112B and the lower metal layer 112C can all terminate together thereby forming the inner end 132 radially inward of the bump 128.

According to other embodiments, the cylinder head gasket 112 can include the upper metal layer 112A, the middle layer 112B and the lower metal layer 112C but without the bump 128 as a feature of any of the upper metal layer 112A, the middle layer 112B or the lower metal layer 112C. Rather, a component such as a metal ring can be welded or otherwise connected to the middle layer 112B such as at an outer edge (e.g., a furthest away portion of the cylinder head gasket 112 from the cylinder) thereof. The metal ring can form a continuous ridge extending circumferentially around and above the cylinder liner 108 between the lower metal layer 112C and the top metal layer 112A (and in some cases being proud of at least one of the lower metal layer 112C and the top metal layer 112A.

As shown in FIG. 3A, the flange 134 projects radially outward over portions of the engine block 102. A fillet 135 can be provided at a junction between the main body portion 133 and the flange 134. This fillet 135 can extend from an outer diameter of the main body portion 133 to a bottom surface of the flange 134. The flange 134 can form part of the outer surface 116 (e.g., can form an entirety of the outer face 116B, the outer face 116B and small portion of the spot face 116A, or a portion of the outer face 116B). The spacer plate 106 can be arranged around the cylinder liner 108 radially outward thereof with respect to the cylinder bore 110. The cylinder liner 108 can be positioned adjacent and inward of a metal band MB and a rubber (or other softer material) over mold OM.

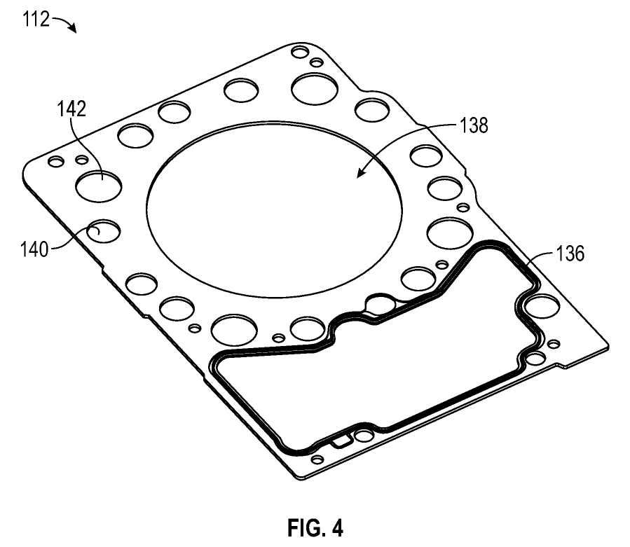

FIG. 4 is a perspective view of the cylinder head gasket 112 additionally showing the shim gasket 136. The water ferrule 114 can be separated from the cylinder head gasket 112 by a shim gasket 136 or another sealing feature as shown in FIG. 4. Shim gasket 136 can form a seal between the cylinder head 104 and the spacer plate 106 for sealing oil, for example. The cylinder head gasket 112 can include a central aperture 138, a plurality of apertures 140 and a water ferrule aperture 142.

The cylinder head gasket 112 can have generally rectangular shape, generally corresponding to the shape of the spacer plate 106 (FIG. 2B). The shim gasket 136 can be positioned generally between the water ferrule aperture 142 and a remainder of the cylinder head gasket 112. The plurality of apertures 140 can be arranged in a pattern around various portions of the cylinder head gasket 112 including adjacent the various edges thereof. The plurality of apertures 140 are configured to receive fasteners (not shown but shown in FIGS. 2A and 3) that couple the cylinder head (not shown) to the internal combustion engine. The central aperture 138 can correspond generally with the cylinder bore 110 (FIG. 2B). The plurality of apertures 140 can be spaced from and patterned around the central aperture 138. Thus, the cylinder head gasket 112 includes the water ferrule aperture 142 therethrough configured to accommodate a water ferrule of the internal combustion engine, the plurality of apertures 140 configured to receive bolts that affix the cylinder head to the internal combustion engine, and the central aperture 138 configured to accommodate the cylinder bore.

### INDUSTRIAL APPLICABILITY

Gaseous fuels have several advantages including cleaner emissions (fewer nitrogen oxides (NOx) and particulate matter compared to conventional fuels like gasoline or diesel), a higher octane number and lower operating costs. However, gaseous fuels pose challenges related to storage, safety and energy density. Additionally, gaseous fuels must be combusted at higher temperatures as compared with diesel and gasoline fuel.

Referring now to FIG. 5, the present application recognizes that the cylinder head gasket 112 can be extended all the way to adjacent the cylinder bore 110 of the cylinder liner 108 such the cylinder head gasket 112 is interposed in a greater area between the cylinder head 104 and cylinder liner 108. This allows the cylinder liner 108 to have a much flatter shape along the outer surface 116 thereof than was previously utilized. Previously, it had been thought, particularly with use of gaseous fuels that combust at higher temperatures, that a fire dam (a projection features) or a particularly designed robust and separate seal was required to be used in this area adjacent the cylinder bore. However, the present application recognizes that use of the fire dam or use of the dedicated seal in this area can create a larger than desired crevice volume and this crevice volume can lead to a chance for gaseous fuel to be trapped in between the cylinder head to engine block joint. This trapped gaseous fuel may not fully ignite and is then expelled with the exhaust. This phenomenon can negatively affect engine performance and emissions.

However, as shown in FIG. 5, the present application further recognizes that a flat surface for the outer surface 116 or a slightly proud surface adjacent the cylinder bore 110 relative to other parts of the outer surface 116 may not desirable from a durability standpoint for the cylinder liner 108. In particular, it was determined that that a flat surface for the outer surface 116 or a slightly proud surface adjacent the cylinder bore 110 relative to other parts of the outer surface 116 caused increase in a stress concentration at the fillet 135 when compression force CF from the cylinder head 104 is applied through the cylinder head gasket 112 down on the cylinder liner 108. It was realized that increased stress concentration at the fillet 135 was due to tension on the main body portion 133. Thus, the design of the cylinder head gasket 112 and cylinder liner 108 of the present application are configured to form a better more efficient seal with reduced the risk of unburned fuel escaping but also provide for a more robust and durable cylinder liner 108 design capable of longer operational life than cylinder liner’s that employed the fire dam or utilized a flat outer surface 116.

With this realization, the present application discloses a modified shape for the cylinder liner 108 having the spot face 116A and the outer face 116B with the spot face 116A recessed the distance D1 below the outer face 116B such that the outer face 116B is proud of the spot face 116A. According to one example, the distance D1 can be between about 10 microns and about 100 microns. With this distance D1 in mind, it should be recognized that the amount of recess illustrated in FIGS. 3A and 5 is schematic and is exaggerated for illustrative purposes as are the gaps between layers of the cylinder head gasket 112 and gaps between components shown in FIGS. 3A and 5.

As further shown in FIG. 5, the spot face 116 can extend outward in the radial direction from or adjacent the cylinder bore 110 and terminates at a location (indicated with line OE standing for outer extent) that is less than or equal to an outermost radial extent of the main body portion 133. This distance D2 for the outer extent of the spot face 116 is illustrate in FIG. 5. However, this distance D2 and the location of the outer extent (indicated by line OE) can vary according to other examples. Indeed, the spot face 116A can extend outward in the radial direction from or adjacent the cylinder bore 110A and can terminate at a location that is between 15% and 65% of an outermost radial extent of the flange 134. Thus, the spot face 116A can be formed entirely by the main body portion 133 (even having the outer extent indicated with line OE recessed back from the outer diameter of the main body portion 133) or can be formed by a combination of a small portion of the flange 134 and the main body portion 133 according to various examples. As discussed above, the spot face 116A is configured to reduce a stress concentration on the fillet 135 between the main body portion 133 and the flange 134 as tensile stress on the main body portion 133 is reduced and a greater proportion of the compression force CF is reacted by the flange 134. Although not illustrated in FIG. 5, it is recognized that when so loaded with the compression force CF a portion of the cylinder head gasket 112 is configured to deform to substantially fill the distance D1 of the spot face 116A.

The present application additionally recognizes a new shape and size for cylinder head gasket 112. As a result, the cylinder head gasket 112 covers and fills substantially more of the crevice volume than would have otherwise been the case in prior designs. Put another way, the crevice volume (an area with no gasket but just space between the liner and the cylinder head) can be substantially reduced by up to 64% in the present internal combustion engine 100. Thus, the cylinder liner 108 and cylinder head gasket 112 are configured to reduce the crevice volume. This reduction can include by eliminating the fire dam of the cylinder liner that had previously used. Additionally, the cylinder head gasket 112 is provided with a relatively larger size and covers more area including the substantially all or all the area between the cylinder head 104 and cylinder liner 108 that had previously not been covered by the cylinder head gasket in prior designs. For example, the cylinder head gasket 112 can extend to or substantially adjacent the cylinder bore 110. As a result, of the larger cylinder head gasket 112 size and lack of features (e.g., projections, grooves, etc.) along the outer surface 116 of the cylinder liner 108, a more robust and efficient seal can be formed.

The above detailed description is intended to be illustrative, and not restrictive. The scope of the disclosure should, therefore, be determined with references to the appended claims, along with the full scope of equivalents to which such claims are entitled.

What is claimed is:

1. A cylinder liner for an internal combustion engine, comprising:
a main body portion forming a cylinder bore of the internal combustion engine, wherein the main body portion has a spot face that is configured to interface with a first portion of a cylinder head gasket;
a flange extending outward from the main body portion, wherein the flange includes a outer face that is configured to interface with a second portion of the cylinder head gasket;
wherein the spot face is recessed a distance below the outer face such that the outer face is proud of the spot face.

2. The cylinder liner of claim 1, wherein the distance is between about 10 microns and about 100 microns.

3. The cylinder liner of claim 1, wherein the spot face extends outward in a radial direction from or adjacent the cylinder bore and terminates at a location that is less than or equal to an outermost radial extent of the main body portion.

4. The cylinder liner of claim 1, wherein the spot face extends outward in a radial direction from or adjacent the cylinder bore and terminates at a location that is between 15% and 65% of an outermost radial extent of the flange.

5. The cylinder liner of claim 1, wherein the spot face is configured to reduce a stress concentration on a fillet between the main body portion and the flange.

6. The cylinder liner of claim 1, further comprising the cylinder head gasket, wherein the cylinder head gasket is interposed between substantially an entirety of the spot face and the outer face and a cylinder head.

7. The cylinder liner of claim 6, wherein the cylinder head gasket is configured to substantially eliminate any direct abutment between the cylinder liner and the cylinder head when the cylinder head compresses the cylinder head gasket.

8. The cylinder liner of claim 7, wherein a portion of the cylinder head gasket is configured to deform to substantially fill the distance of the spot face and engage the spot face when the cylinder head compresses the cylinder head gasket.

9. An internal combustion engine comprising:
a cylinder head;
an engine block;
a cylinder liner received at least partially within the engine block, wherein the cylinder liner includes a main body portion that forms a cylinder bore configured to receive a piston therein and a flange extending outward from the main body portion, wherein the main body portion has a spot face and the flange has an outer face, and wherein the spot face is recessed a distance below the outer face such that the outer face is proud of the spot face; and
a cylinder head gasket arranged between substantially an entirety of the spot face and the cylinder head and arranged between substantially an entirety of the outer face and the cylinder head, wherein the cylinder head gasket forms a seal with the spot face and the outer face.

10. The internal combustion engine of claim 9, wherein the spot face and the cylinder head gasket extend to or adjacent one of: the cylinder bore or a cuff ring received by the main body portion and positioned around the cylinder bore.

11. The internal combustion engine of claim 9, wherein the distance is between about 10 microns and about 100 microns.

12. The internal combustion engine of claim 9, wherein the spot face extends outward in a radial direction from or adjacent the cylinder bore and terminates at a location that is less than or equal to an outermost radial extent of the main body portion.

13. The internal combustion engine of claim 9, wherein the spot face extends outward in a radial direction from the cylinder bore and terminates at a location that is between 15% and 65% of an outermost radial extent of the flange.

14. The internal combustion engine of claim 9, wherein the spot face is configured to reduce a stress concentration on a fillet between the main body portion and the flange adjacent an area that the flange engages the engine block.

15. The internal combustion engine of claim 9, wherein the cylinder head gasket is configured to substantially eliminate any direct abutment between the cylinder liner and the cylinder head when the cylinder head compresses the cylinder head gasket.

16. The internal combustion engine of claim 15, wherein a portion of the cylinder head gasket is configured to deform to substantially fill the distance of the spot face and engage the spot face when the cylinder head compresses the cylinder head gasket.

17. The internal combustion engine of claim 9, wherein the internal combustion engine is a gas engine configured to combust a gaseous fuel.

18. A method of sealing a cylinder bore of an internal combustion engine, comprising:
providing a cylinder head and a cylinder liner that defines the cylinder bore, wherein the cylinder liner includes a spot face extending from the cylinder liner and the cylinder liner includes an outer face radially outward of the spot face, and wherein the spot face is recessed a distance below the outer face such that the outer face is proud of the spot face with respect to the cylinder head;
interposing a cylinder head gasket between the cylinder liner and the cylinder head to cover substantially all of the spot face and substantially all of the outer face; and
compressing the cylinder head gasket against the spot face and the outer face.

19. The method of claim 18, further comprising positioning the cylinder head gasket to cover substantially all of a joint between cylinder liner and the cylinder head such that the cylinder head gasket extends to or adjacent one of: the cylinder bore or a cuff ring received by the cylinder liner and positioned around the cylinder bore.

20. The method of claim 18, wherein the distance is between about 10 microns and about 100 microns, and wherein sealing includes sealing a gaseous fuel.
